(19) United States
(12) Patent Application Publication
(10) Pub. No.: US 2006/0235830 A1
(43) Pub. Date: Oct. 19, 2006

(54) Web content administration information discovery

(75) Inventors: Andrew Cheng-min Lin, Seattle, WA (US); Nikhil Kothari, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/107,472

(22) Filed: Apr. 14, 2005

(51) Int. Cl. G06F 17/30

(52) U.S. Cl. 707/3

(57) ABSTRACT

Web content administration information can be discovered by users through using an administration tool that provides a way for web sites and/or applications to automatically provide the administration tool with information on how to connect to the administration service. A user specifies a URI that is associated with a content source for which administrative services are desired. The administration tool queries the content source for administration information that is associated with the desired administration services. The administration tool typically forms a URI in response to the administration information such that the URI determines a connection (or connection information) to the administration service that is associated with the determined administration information.

### BACKGROUND

Many companies and individuals have web sites that are hosted by third party internet hosting services. Often, owners of such web sites do not have complete administrator-level access to the machines that host the web sites. However, the owners usually need to perform some administration services on their web sites, which usually entails using some kind of administration tool.

Conventional administration tools typically consume a separate service that is dependent on the web server itself. Because the administration tool service is typically dependant on the web server itself, an administration mistake could render the web server unusable (often for both the server and the administration tool). Separating the administration functions from the web site hosting can make the system more robust, but this often may lead to discovery problems. Discovering how to connect to this administration service might not be easy or possible for the typical owner of the content of a web site. Connecting might not be easy for the owner because the owner may need to specify various parameters (such as server name, port number, site name, application name, and the like), which are subject to change and are often difficult for human operators to remember.

### SUMMARY

The present disclosure is directed to discovery of connection related information for performing administration of web content, sites and applications. An administration tool provides a way for web sites and/or applications to automatically provide the administration tool with information on how to connect to the administration service. A user specifies a URI that is associated with a content source such as the site and/or application for which administrative services are desired. The administration tool queries the specified content source for administration information that is associated with the desired administration services. The administration tool typically forms a URI in response to the administration information such that the URI determines a connection (or connection information) to the administration service that is associated with the determined administration information.

In accordance with one aspect of the invention, a computer-implemented method is disclosed for discovering web content administration information, comprising: determining a first URI for a content source upon which a content owner desires to perform administrative functions; sending a query using the first URI wherein the query requests administration information that is associated with the first URI; in response to the query, receiving the requested administration information; and using the requested administration information to communicate with an administrative service, whereby administrative functions are performed on the content source determined by the first URI.

### BRIEF DESCRIPTION OF THE DRAWINGS

FIG. 1 illustrates a computing device that may be used according to an example embodiment of the present invention.

FIG. 2 illustrates a block diagram of a system for discovery of information for administration of web content in accordance with aspects of the present invention.

### DETAILED DESCRIPTION OF THE PREFERRED EMBODIMENT

The present disclosure is directed to discovery of web content administration information. An administration tool provides a way for web sites and/or applications to automatically provide the administration tool with information on how to connect to the administration service. A user specifies a URI that is associated with a content source for which administrative services are desired. The administration tool queries the associated content source for administration information that is associated with the desired administration services. The administration tool typically forms a URI in response to the administration information such that the URI determines a connection (or connection information) to the administration service that is associated with the determined administration information.

Embodiments of the present invention now will be described more fully hereinafter with reference to the accompanying drawings, which form a part hereof, and which show, by way of illustration, specific exemplary embodiments for practicing the invention. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Illustrative Operating Environment

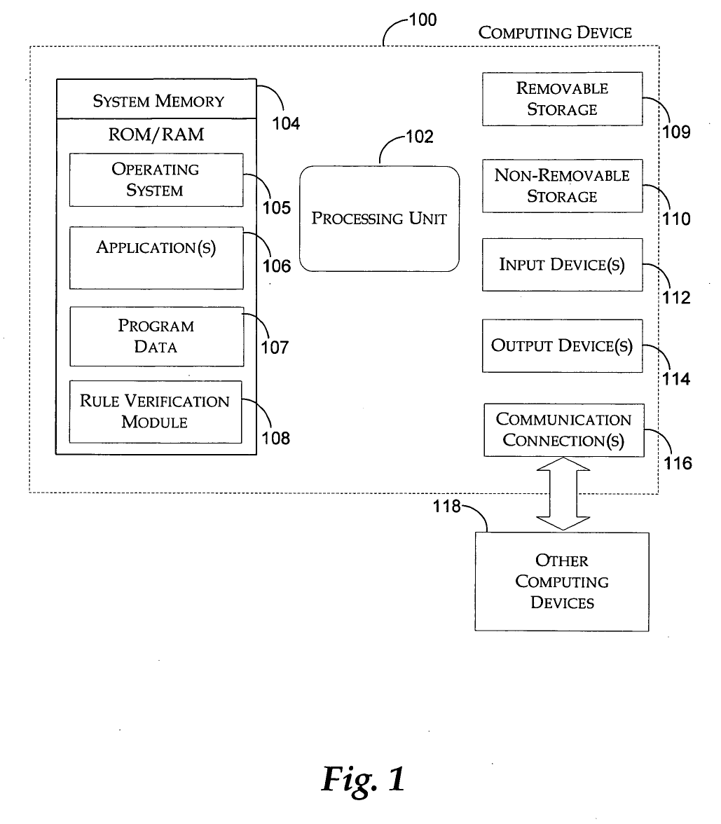

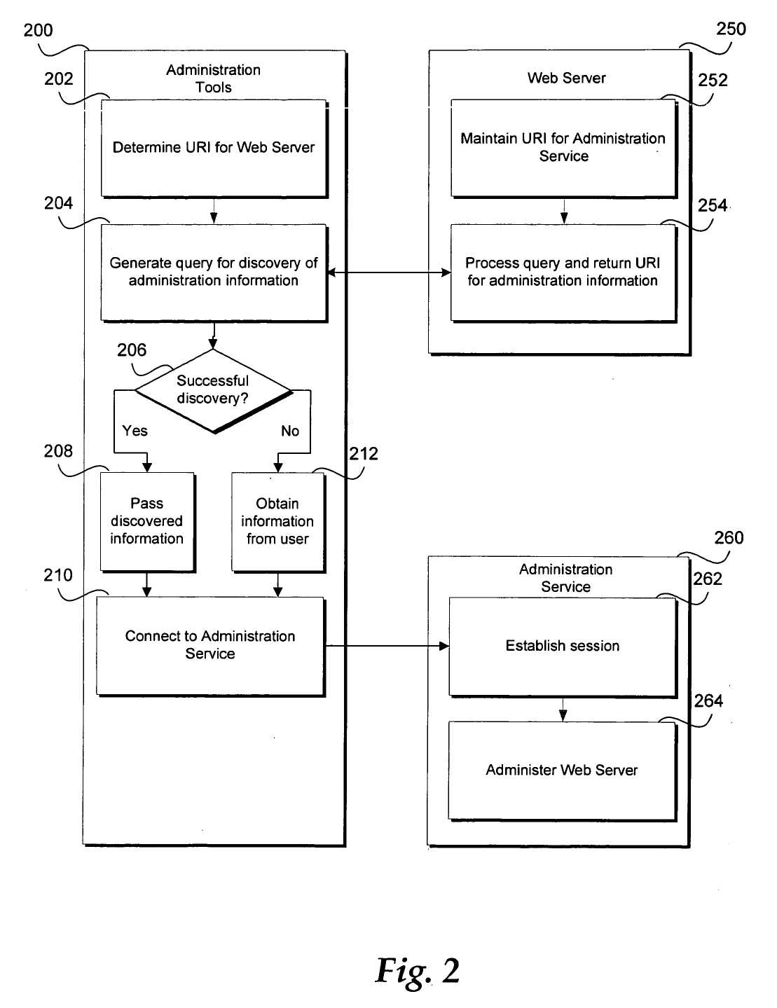

With reference to FIG. 1, one example system for implementing the invention includes a computing device, such as computing device 100. Computing device 100 may be configured as a client, a server, a mobile device, or any other computing device that interacts with data in a network based collaboration system. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. A rule verification module 108, which is described in detail below with reference to FIGS. 2-4, is implemented within system memory 104.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Networks include local area networks and wide area networks, as well as other large-scale networks including, but not limited to, intranets and extranets. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Web Content Administration Information Discovery

Many people and organizations who want to publish content on the internet typically do not want to bear the expense and trouble of maintaining their own web sites. Accordingly, these web site customers often use third party services to host the web site and provide administration services to maintain, configure, and add content to the web sites that are hosted by web servers.

Typical implementations of web servers and associated administration services are configured such that the administration service is dependent on the web server. However, where the administration service is dependent on the web servers, no administration can be performed using a crashed web server to fix the problem. Accordingly, there is a need for typical implementations of web servers and associated administration services to segregate the functions of site administration and web site hosting.

However, the segregation of the web hosting and administration of the web sites by third parties can present burdens. For example, hosted web site customers may find if difficult to know how to connect to the administration services when they do not know and cannot lookup the names and identifiers of the site on the server as defined in server configuration or when the server configuration changes, and the address for the administration server changes. In accordance with the present invention, a discovery mechanism is provided such that a web server is configured to automatically provide information for connection to the administration service.

The provided information may include, for example, a “human-friendly” identifier of the site or application, an identifier (such as a URI) that is associated with the administration service, contextual information about the server about which operating system under which the server is operating, the revision level of the operating system, the IP address port number, which protocol may be used to connect to management services (such as https), and the like. Accordingly, the discovery mechanism can be used to expose a breadth of the information that is associated with both the administration service and the hosted website.

FIG. 2 illustrates a block diagram of a system for discovery of information for administration of web content in accordance with aspects of the present invention. The system is described with reference to a networked system, such as a system formed using the internet, where web content can be requested and served. However, the system is not limited to the web space. The system may be implemented using any type of network where administration services for web content servers are segregated (in whole or in part) from the web content servers themselves.

The system includes administration tools 200, web server 250, and administration service 260. Administration tools 200 may be implemented on a single machine, or distributed across a portion of a system that is controlled by the web content owner who controls the content that is hosted on a third party web server. Web server 250 likewise can be hosted on a single machine, a web farm, and the like, such that web server 250 resides on a portion of a system that is controlled by the third party and that is segregated, in part or in whole, from administration service 260. Administration service 260 can be hosted on a single machine, a web farm, and the like, such that administration service 260 resides on a portion of a system that is controlled by the third party and that is segregated, in part or in whole, from web server 250.

In accordance with the present invention, an owner of web site content desires to have the content hosted on web server 250, which is typically provided by a third party for the use of content owners. The content owners typically create or select of the content that is to be hosted on the web site. The content owner uses the services of the third party to host the content on web server 250, wherein a URI (a universal resource indicator or any other suitable identifier) is associated with the hosted web site.

The content owner typically operates within the context of administration tools 200, which provides a user interface and communication facilities that can be used to administer the hosted web site. In block 202, the content owner uses administration tools 200 to select or provide a URI that is associated with the hosted web site. The content owner can select or provide the URI in the context of choosing to perform maintenance on the web server.

Additionally, the content owner can select or provide the URI merely by choosing to browse the page, wherein the URI can be cached for later usage. Likewise, a control on the web page can be activated by the content owner, wherein the control can be used to initiate the query for discovery of the administration information. As discussed below, the content owner and/or the administration tools 250 can be authenticated in order to implement desired security policies.

In block 204, administration tools 200 generate a query that is used to discover information from web server 250. Web server 250 receives the request and returns information to administration tools 200 that can be used to connect to the administrative functions on web server 250.

In various embodiments, the content owner and/or administration tools 200 can be authenticated to implement desired security policies. In an embodiment, web server 250 can request a user name/password combination to authenticate the request from administration tools 200.

Web server 250, as discussed above, is typically hosted by a third party that maintains administration information for discovery by administration services 200. In block 252, web server 250 maintains information about the administration service that can be used to perform maintenance on web server 250. The information about the administration service can be stored and maintained on web server 250 by the third party and/or hosting services provided by the third party.

In block 254, web server 250 receives the query from block 204. The query is processed and the administration information is returned to administration tools 200. In various embodiments information can be directly passed and/or a pointer (such as a URI) can be returned.

In block 206, a determination is made as to whether the desired information has been returned. The determination can be made by various methods including checking this syntax of the response, verifying whether a returned URI points to the desired information, and the like.

If the desired information has been discovered successfully, in block 208 the discovered information is passed to block 210, which uses the discovered information to connect to administration service 260. If the desired information has been not discovered successfully, the content owner can be prompted to supply missing information, such as by typing in the URI of administration service 260.

In block 262, a session is established with administration service 260, wherein the session is typically used to perform administrative services for web server 250. In block 264, administrative services can be performed for web server 250. Accordingly, administrative services can be performed on content of web server 250 without even requiring the content owner to be aware of the locator or the indicator that is associated with administrative service 260.

Furthermore, the third party host of web server 250 and/or administrative service 260 can change a URI that is associated with administration service 260 at anytime without having to notify content owner (because the URI can be subsequently and automatically be discovered by administration tools 200). The URI can comprise arbitrary content that can be changed periodically, which allows security to be enhanced.

In an example scenario, a client application (such as administration tool 200) is resident on a content owner system and administration services 260 are resident on the same system as the web server 250. The first time a content owner starts to administer or manage web content of the content owner, administration tool 200 can launch a wizard, which can guide and assist the content owner in connecting to the administration service.

Initially, the content owner can be prompted to supply the URI that is associated with the web content that is posted on web server 250 (which is typically owned by a third party). Administration tool 200 uses the associated URI to generate one or more queries (via HTTP) using a specific HTTP handler at the associated URI (e.g., http://localhost/wmdisco.axd).

If web server 250 is available, the HTTP handler typically returns desired administration information that can be used by administration tools 200 to connect to the administration service (including, for example, the administration service machine name, port, web site name, and web application name). If web server 250 is not available (in which case the HTTP handler cannot be run), administration tools 200 can provides a way for the user to automatically specify the administration information.

Once administration tools 200 has acquired the administration information, the administration information can be used to connect to the administration service, which allows the content owner to manage the web content. Administration tools 200 can connect to the administration service by, for example, forming a URI in response to the returned administration information by modifying a portion of a pathname (returned in the administration information) with a string such as “/service.axd” to form a link to point to the administration service.

In various embodiments, the content owner and/or administration tools 200 can be authenticated to implement desired security policies. In an embodiment, web server 250 can request a user name/password combination to authenticate the query for discovery of administration information from administration tools 200. Additionally, security policies can be implemented by requiring authentication during the establishment of the session in block 262. Furthermore, security policies can be maintained through a context that is established when the content owner uses administration tools 200.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer-implemented method for discovering web content administration information, comprising:
determining a first identifier for a content source upon which a content owner desires to perform administrative functions;
sending a query using the first identifier wherein the query requests administration information that is associated with the first identifier;
receiving the requested administration information in response to the query; and
using the requested administration information to communicate with an administrative service, whereby administrative functions are performed on the content source determined by the first identifier.

2. The computer-implemented method of claim 1, wherein the requested administration information is supplied by the content source determined by the first identifier.

3. The computer-implemented method of claim 1, wherein the requested administration information is supplied by the content owner.

4. The computer-implemented method of claim 3, wherein the content owner supplies the requested administration information when the content source determined by the first identifier fails to provide the requested administration information.

5. The computer-implemented method of claim 1, wherein the requested administration information is cached after the administration information is received.

6. The computer-implemented method of claim 1, wherein the query is sent in response to browsing the content source determined by the first identifier.

7. The computer-implemented method of claim 1, wherein a second identifier is formed in response to the received requested information.

8. The computer-implemented method of claim 7, wherein the administrative functions are performed using the second identifier.

9. The computer-implemented method of claim 8, further comprising authenticating the query for requesting administration information.

10. The computer-implemented method of claim 9, wherein the second identifier is further formed by including in the second identifier arbitrary information derived from the received requested information.

11. A computer-readable media for discovering web content administration information, comprising instructions for:
determining a first identifier for a content source upon which a content owner desires to perform administrative functions;
sending a query using the first identifier wherein the query requests administration information that is associated with the first identifier;
receiving the requested administration information in response to the query; and
using the requested information to communicate with an administrative service, whereby administrative functions are performed on the content source determined by the first identifier.

12. The computer-readable media of claim 11, wherein the requested administration information is supplied by the content source determined by the first identifier.

13. The computer-readable media of claim 11, wherein the query is sent in response to browsing the content source determined by the first identifier.

14. The computer-readable media of claim 11, wherein a second identifier is formed in response to the received requested information.

15. The computer-readable media of claim 14, wherein the second identifier is formed by including in the second identifier a predetermined string that is associated with the administrative functions.

16. A system for discovering web content administration information, comprising:
means for determining a first identifier for a content source means upon which a content owner desires to perform administrative functions;
means for sending a query using the first identifier wherein the query requests administration information that is associated with the first identifier;
means for receiving the requested administration information in response to the query; and
means for using the requested information to communicate with an administrative service, whereby administrative functions are performed on the content source determined by the first identifier.

17. The system of claim 16, wherein the requested administration information is supplied by the content source means determined by the first identifier.

18. The system of claim 16, wherein the query is sent in response to browsing the content source means determined by the first identifier.

19. The system of claim 16, further comprising means for authenticating the query for requesting administration information.

20. The system of claim 19, wherein the second identifier is formed by including in the second identifier a predetermined string that is associated with the administrative functions.
